(19) United States
(12) Patent Application Publication
(10) Pub. No.: US 2011/0103656 A1
(43) Pub. Date: May 5, 2011

(54) Quantification of Plaques in Neuroimages

(76) Inventors: Gheorghe Iordanescu, Skokie, IL (US); Palamadai N. Venkatasubramanian, Morton Grove, IL (US); Alice Wyrwicz, Lake Forest, IL (US)

(21) Appl. No.: 12/762,179

(22) Filed: Apr. 16, 2010

Related U.S. Application Data
(60) Provisional application No. 61/170,457, filed on Apr. 17, 2009.

(51) Int. Cl. G06K 9/00

(52) U.S. Cl. 382/128

(57) ABSTRACT

A system and method for determining the location and density of plaques in a neuroimage is disclosed according to one embodiment of the invention. In some embodiments, catchment basins are identified as potential plaque areas (candidate regions) in the neuroimage. The Laplacian of each element within the catchment basins can be calculated and the highest Laplacian in the catchment basin identified as a candidate feature. The local contrast can be computed as the ratio between the local minimum of the catchment basin and the average (or some other statistic like the maximum or minimum) intensity of the neighboring watersheds can be used as another candidate feature. In some embodiments, a classifier can be used to discriminate the candidates into plaques or non-plaques, since plaques tend to have a larger Laplacian and larger local contrast than other brain structures.

### CROSS REFERENCE

This application claims the benefit of U.S. Provisional Patent Application No. 61/170,457, entitled “Quantifications of Plaques in Neuroimages,” filed Apr. 17, 2009, the entire disclosures of which are incorporated herein by reference for all purposes.

### BACKGROUND

Alzheimer's Disease affects as many as 26 million people worldwide. Despite the disease'subiquity, it is difficult to accurately diagnose. Typically, neuropyschological analysis, such as behavioral assessments and/or cognitive testing, can be used in diagnosis. However, such analysis is not predictive and can have statistical uncertainties that are unsettling. There is support for the theory that deposition of the β-amyloid peptide (Aβ) is an important pathological hallmark of the disease. Despite the well established significance of amyloid plaques in Alzheimer's Disease, diagnosis of the disease on this basis has not been possible, primarily due to the lack of reliable visualization techniques. Currently, the presence of Aβ plaques in humans is confirmed only by postmortem histological analysis.

### BRIEF SUMMARY

Alzheimer's disease as well as other neurodegenerative diseases are associated with plaques and tangles in the brain. These buildups have been difficult to quantify in vivo. In some situations, Alzheimer's can be a suspected diagnosis, but it cannot be confirmed until an examination of plaques and/or tangles in the brain has occurred postmortem. Embodiments disclosed herein (including the appendix) can be used for isolating and/or segmenting amyloid plaques in neuroimages. Some embodiments of the invention allow for in vivo or ex vivo determination of plaque and/or tangle build up or reduction (as a result of therapeutic intervention) in a patient or an animal subject such as an APP transgenic mouse or any other animal model of Alzheimer's disease. Some embodiments of the invention allow for in vivo or ex vivo determination of plaque build up in cerebral blood vessels, which is known as Cerebral Amyloid Angiopathy (CAA), in a patient or in an animal model. Embodiments disclosed herein can be used for detecting and/or quantifying neuritic plaque burden as found in subjects who have Parkinson disease (PDD) or dementia with Lewy bodies (DLB) both in humans or animal models.

Embodiments of the present invention include novel automatic segmentation schemes for characterizing plaques in the brain. In some embodiments, the combination of watershed transform, local intensity variation features, Hessian Matrix eigenvalues, and/or unsupervised classification can be used for segmentation. Embodiments of the invention have been validated by comparison with histology data and have demonstrated to have the ability to quantify amyloid depositions in a 5×FAD APP transgenic mouse model with Alzheimer's disease at low (0%), medium (10%) and high (20%) ranges in multiple brain regions that are Alzheimer's disease-relevant. 3D plaque distribution within a brain region can be obtained using these methods. Certain measures may be used to obtain a detailed pattern analysis of plaques, which can also be computed. Indeed, a wide variety of other measures can be derived from the 3D plaque distribution. For example, plaque density or plaque load distributions can be obtained in an arbitrarily oriented plane by collapsing one dimension, or along an axis by collapsing two dimensions. As the 5×FAD model is characterized by dense, relatively small, punctuate plaques, this method may also be readily applicable to other transgenic models which exhibit larger plaques that are easier to detect.

The following detailed description together with the accompanying drawings will provide a better understanding of the nature and advantages of the present invention.

### BRIEF DESCRIPTION OF THE DRAWINGS

FIG. 1 shows a flowchart of a method for classifying regions of a neuroimage as plaque or non-plaque according to some embodiments of the invention.

FIG. 2A-FIG. 2D graphically showing how a classifier can be trained on known data and then applied to unknown data according to some embodiments of the invention.

FIG. 3 shows a computational system that can be used in conjunction with embodiments of the invention.

### DETAILED DESCRIPTION

Some embodiments of the present invention can use previously identified plaque regions to compute a classification function (e.g., a machine learning algorithm or system) to classify plaques within a neuroimage. Some embodiments of the invention also identify plaque regions and/or non-plaque regions in a neuroimage using the classification function. In some embodiments, voxel clusters (e.g., candidate regions or catchment basins) of the neuroimage can be calculated. In some embodiments, for example, the Laplacian or Hessian Matrix eigenvalues can be calculated for each voxel of the neuroimage and/or for the catchment basins. The classification function can then be applied based on these values or derivations thereof or based on any other classifiers and/or features to identify plaque regions.

Embodiments of the present invention can be used to identify and/or quantify amyloid plaques in the brain from neuroimages of live or deceased patients or animal subjects. Once quantified, this data can be used to diagnose Alzheimer's disease or other pathologies. In some embodiments, a neuroimage can be captured using a brain scan device, a neuroimage can be retrieved from memory, or a neuroimage can be imported from an external source. The neuroimage can include a direct or indirect image of the brain. Neuroimages can include images collected from an MRI scan, CAT scan, CT scan, EROS scan, FMRI scan, MEG scan, PET scan, or a SPECT scan. A neuroimage can be a two-dimensional image, a three-dimensional image, a four-dimensional image, or a neuroimage with any number of dimensions. For instance, a neuroimage can include a collection of pixels arranged in 2-dimensions or voxels arranged in 3-dimensions.

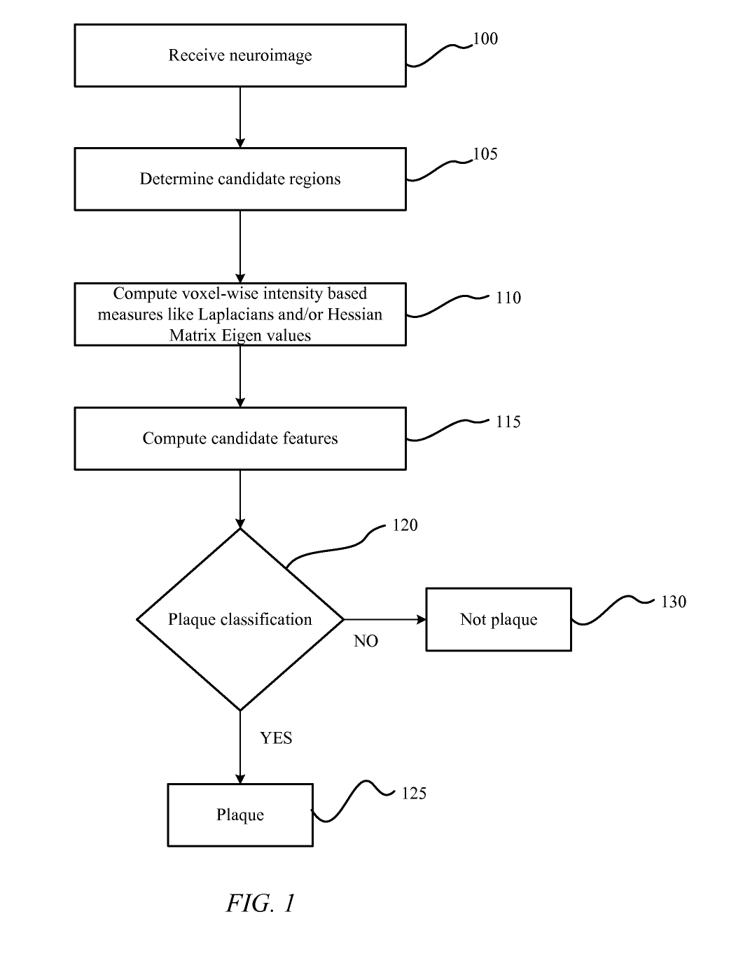

In some embodiments, portions of a neuroimage can be classified as plaque regions, for example, using the method shown in FIG. 1. In some embodiments, β-amyloid peptide deposition is the plaque of interest in the diagnosis of Alzheimer's disease. However, other plaques, tangles, buildups, deposits, etc. may be of interest and may also be classified using embodiments disclosed herein. As shown in FIG. 1, a neuroimage can be received at block 100. At block 105, candidate regions within the neuroimage can be identified, for example, using a watershed algorithm that isolates catchment basins (CBs). The watershed transform can extract regions with low intensities completely surrounded by higher intensity neighbors. Such regions can be identified as candidate regions. In some embodiments, other clustering algorithms/methods can be applied to the neuroimage to obtain candidate regions.

A watershed transform can produce an image, WS(I), that is a map of the catchment basins in the neuroimage I, where each voxel has a label that defines the catchment basin of a neuroimage local minimum. Watersheds, which can be defined as borders between catchment basins, can be ignored since they represent places of local maxima or ridges. WS(I) is a voxel-wise function that provides an exhaustive collection of plaque candidates as defined by the I catchment basins:

CB={CB(j)|CB(j)=∪Vᵢ(x,y,z),WS(Vᵢ)=j,j=1 . . . N_{CB}}

where Vᵢ(x, y, z) is the i^{th} voxel of image I, at coordinates (x,y,z), and N_{CB} is the total number of catchment basins in I.

At block 110 the Laplacian operator can be applied to each of the pixels or voxels within the candidate regions with respect to its nearest neighbors. Because plaques can be defined as spatial regions with small derivatives surrounded by neighbors with rapidly increasing intensity, the Laplacian operator can be used. The Laplacian operator, L(I)=∇·∇(I), represents the divergence of the gradient in neuroimage I. It can be seen as a signed measure of the local signal variation (e.g., the data gradient field's source or sink at a given point). Because amyloid plaques produce a signal drop, they can be modeled as sources whose gradient vectors are pointing toward the watersheds in the direction of the steepest path. Plaques can also have a larger Laplacian than the background brain structures or local noise. The Laplacian can be computed for each voxel using its neighborhood intensity values. The result of this preprocessing step (e.g., blocks 105 and/or 110 of FIG. 1) is a map of the catchment basins for the image in which each voxel is characterized by its Laplacian. In other embodiments Hessian Matrix eigenvalues can be computed at block 110 instead of or in addition to the Laplacian.

In some embodiments, block 110 can occur prior to block 105. In other embodiments blocks 105 and 110 can occur in parallel.

At block 115 candidate features can be identified. In some embodiments, one or more candidate features can be computed: 1) the highest Laplacian value within a candidate region and/or 2) the contrast between a candidate region and its border region. In other embodiments, a combination of Hessian Matrix eigenvalues that discriminate blobs around local minima against other shapes like cylinders (induced for example by blood vessels) or sheets (induced for example by interfaces between brain regions) can be used to provide candidate features. The contrast can be defined as the ratio between the maximum and minimum neuroimage intensity in a candidate region. Moreover, the contrast can be a local intensity feature that allows the normalization of plaque-induced signal drop using the local catchment basin values in order to compare brain regions that have different image intensities.

In some embodiments, other features can be calculated alone or in combination with the previous features. These can include, for example, minimum eigenvalue of the Hessian matrix, Hⱼₖ(I)=DⱼDₖ(I), the square matrix of the second-order partial derivatives of the image. The Hessian eigenvalues provide a curvature analysis that is independent of the data coordinate system and can be used to determine the voxel's likelihood of belonging to a blob, a saddle region, a cylinder, or a sheet. The Hessian matrix eigenvalues can be used to differentiate points with large Laplacians into blobs induced by local minima (e.g., when all three eigenvalues are large positives), saddle points (e.g., where some eigenvalues are positive, and other eigenvalues are negative), dark cylinders produced by blood vessels (e.g., where one eigenvalue is close to zero, and the other two eigenvalues are large positives), or dark sheets generated by the borders between brain regions (e.g., when two eigenvalues are close to zero and the third eigenvalue is a large positive). The minimum eigenvalue (or other combinations of Hessian matrix eigenvalues) can thus be used to discriminate the plaque blobs induced by local minima from all other shapes that may result in large Laplacians (and thus cannot be distinguished by using Laplacians).

At block 120 plaque classification can be determined. Various techniques can be used to identify plaques. Depending on the features used, a plaque can be determined when the highest Laplacian value within a candidate region is greater than a threshold, when the contrast between the candidate region and its border region is higher than a threshold value, and/or based on the Hessian Matrix eigenvalues. If the candidate region includes a plaque(s), then at block 125 the candidate region can be defined as a plaque region; if not, at block 130 the candidate region can be defined as a non-plaque region.

Referring back to block 105, other clustering techniques can be used. For example, region growing algorithms can be used. In such algorithms, seeds can be placed at local minima, and some criteria (i.e. parameters) can be applied to control the volume of each grown region. An example of such a clustering method is the use of an intensity threshold that can be made adaptive, for example, by linking it to the local minimum. The grown region could be thus limited to the voxels that are spatially close to the local minimum and lower than the local intensity threshold, computed as the 1.1 times the local minimum intensity threshold. While it is possible that some minima will be merged together by such thresholding, this is less likely to happen for plaques. Furthermore, the amplitude of the adaptive threshold could be optimized to minimize merging.

Furthermore, shape based features can be used to describe the plaque candidates. A shape features paradigm can use voxel coordinates (not intensities) to compute some compact representation (the feature vector) that describes the shape of objects such as the plaque candidates. The feature vector can be used to measure the similarity between two given shapes using some distance measure. Such similarity measures can be invariant to Euclidean motion and can thus be used to compare objects, and select similar ones independent of their position. Plaque shapes are expected to be various, such as round or stellar. If their pattern is consistent within one class (plaque/or non-plaque class) then they can be used for classification (i.e. for plaque discrimination).

Referring back to block 115, other techniques can be used. Such techniques can be required to be powerful enough to discriminate plaques. The techniques may also be required to match the visible effect of a plaque (hypo-intense area) in a neuroimage. Moreover, these techniques may also allow for plaque shapes and volumes to change over time. This can be useful for longitudinal studies or in studies where changes in plaque shapes and volumes are of interest.

Referring back to block 120, candidate regions can be identified using any number of algorithms and/or procedures. Some examples of methods are described below and others can be developed without deviating from the scope and spirit of the inventions. These embodiments can identify regions corresponding to plaque or non-plaque using the candidates or data described above. In some embodiments, the results are binary; either the region is labeled plaque or it is not. Some of these methods can include a support vector machine (SVM), watershed methods, clustering methods, histogram-based methods, edge detection methods, region growing methods, level set methods, graph partitioning methods, model based segmentation, and/or multi-scale segmentation.

Moreover, still other classification schemes can be used. For example simple thresholding of the CBML can be used. Other examples can include supervised SVM (TCSVM) and fuzzy clustering.

In some embodiments, a one-class SVM learning method can be used to discriminate regions of plaques from candidate regions defined by catchment basins. A one-class support vector machine, for example, is an unsupervised, nonparametric classification approach that trains on control datasets where the plaques are not present.

In some embodiments, two-class SVM training can use a set of training samples (i.e. an array of features and their associated class labels) to find a linear function (a classification hyperplane) that maximizes the margin between the two-classes. Kernel methods such as Radial Basis Function can be used to project the data into a higher dimensional feature space, where a linear classification is equivalent to a nonlinear classification in the original data space. A modified two-class SVM version (e.g., the Soft Margin method) can be used, which can allow for mislabeled examples when there is no hyperplane that can split the two-classes' examples). The method can use slack variables, ζᵢ, which measure the degree of misclassification. Given training vectors xᵢεRⁿ; i=1 . . . N, in two-classes, and a vector yεR^{N} such that yᵢε{−1,1}, a two-class SVM solves the quadratic programming problem:

$$min ( \frac{1}{2} {‖ w ‖}^{2} + C \sum {ξ}_{i} ) ,$$

subject to y, (w·φ(x)+b) where i=1, 2, . . . , N; ζᵢ≧0

A one-class SVM can be considered an extension of a two-class SVM. A one-class SVM can estimate a classification function in the feature space that encloses a majority of the training data. A ν-SVM is a modified one-class SVM implementation that uses a dataset drawn from an underlying probability distribution, P. One-class SVM can estimate a subset, S, of the input space where the probability that a test point from P lies outside of S is bounded by a priori specified ν in the range of (0, 1). Thus, ν is an upper bound on the fraction of outliers, as well as a lower bound on the fraction of support vectors. This approach is equivalent to computing the classification function which separates the positive labeled data from the origin at a threshold ρ. In addition to ν-SVM, which treats the origin as the only member of the second class, a second one-class SVM implementation can be used to compute a minimum volume hypersphere that contains most data in the feature space.

In some embodiments, the ν-SVM classification function can be computed by solving the following quadratic programming problem:

$$min ( \frac{1}{2} {‖ w ‖}^{2} + \frac{1}{ν N} \sum {ξ}_{i} - ρ ) ,$$

subject to (w·φ(xᵢ))≧ρ−ζⱼ, where i=1, 2, . . . , N; ζᵢ≧0

In some embodiments, SVM training can be performed in two stages. First, a one-class SVM classifier is trained on the non-plaque features extracted from 3D regions of interest in a control dataset. Any catchment basin that has features different from those in the training dataset can be classified as plaque. In the second stage, the initial one-class SVM classifier is applied to a region of interest with a large plaque density. This process creates a training dataset for the second and final two-class SVM classifier that is trained in a classical supervised way. The resulting two-class SVM classifier is then applied to all the other datasets to segment plaques in regions of interest defined in the brain. The combined one-class and two-class SVM methods produce results that are less dependent on the ν parameter, if prototype selection techniques are used to refine the one-class SVM model. In some embodiments, the one-sided (i.e., always positive) contrast difference between plaques and non-plaque catchment basins can be used to show that the segmentation results are stable over a large ν range without using prototype selection techniques.

In some embodiments, classification can be implemented, for example, using LIBSVM (an established library for support vector machines), an integrated tool for support vector classification and regression which can handle both two-class and one-class SVM. The radial basis function (RBF) kernel, k(x; xᵢ)=exp(−γ*∥x−xᵢ∥²), can be used, where y determines the kernel width. Its value (γ=0.1) can be chosen to produce a single one-class SVM cluster with a smooth boundary in the original feature space. The two-class SVM C parameter can be used with the default value (1). Various other program code and/or program libraries can be used to implement all or part of the classification algorithms. Moreover, classification algorithms can be implemented using custom generated computer code.

To estimate the one-class SVM ν parameter, a trade-off between its two interpretations, as described by the false positives (FP) dependency on OCSVM parameter ν (FP(ν) function), can be used. On one hand, ν represents the upper bound for the outlier ratio of plaque classified catchment basins to the total number of catchment basins in the processed brain structure. Since one-class SVM is trained on a non-plaque dataset, ν can be close to zero.

However, when ν→0, the one-class SVM separation function can behave like an expanding hyper-sphere that encompasses an increasing number (e.g. 1−ν) of control catchment basins. Low ν values correspond to a sensitive classifier with low false negative (FN) rates but with large FP rates. On the other hand, when ν is large, the hyper-sphere tightly encloses non-plaque points, which can lead to a specific classifier characterized by large FN and low FP rates. In some embodiments, ν can also be viewed as the upper bound for the number of support vectors that are used to compute the separation hyper-sphere describing the non-plaque catchment basins. In some embodiments, ν values larger than zero can be used to include enough support vectors into the one-class SVM model. The table shown below summarizes three proposed independent measures for characterizing the FP(ν) function, their bounds, and the estimated ν values.

The first measure used for ν estimation is called FPνR and is computed as the ratio between the false positives (FPs) and ν. FPνR can be introduced since the proposed algorithm does not include catchment basin size in the classification step, so the volume of the plaque labeled catchment basin described by false positive ratio is not restricted by any bound. In contrast, the number of plaque catchment basins can be capped by ν since ν controls the number, but not the volume, of one-class SVM outliers. FPνR is thus a ν independent measure of the algorithm performance, and we can choose the unit (1) as its upper limit to ensure a maximum ν with reduced FP-ν dependency. FP′ (false positive first derivative) is the second ν estimation measure, independent of FPνR. It can be chosen to be upper bounded by the unit (1) for the same reasons of balancing a reduced FP(ν) dependency obtained by low ν values with a tight one-class SVM separation function that corresponds to large ν values. Finally, the behavior of the FP(ν) function in the following table suggests the extrinsic curvature κ_{false positive} of FP(ν) as the third measure that can be used for ν estimation. While the single one-class SVM approach has a nearly linear behavior, the proposed combined one-class and two-class SVM approach has two regions with different slopes. When ν is below 2.5%, the resulting false positive is almost zero. This range can correspond to one-class SVM hyper-spheres that include large regions in the feature space that are classified as non-plaques even if they are populated by very few non-plaques samples. The resulting reduced false positive rates in this ν range are counter-balanced by potentially increased false negatives rates. By increasing ν above 2.5%, the one-class SVM separation function becomes smaller and more specific about-non-plaque values, so that larger false positive ratios are compensated by smaller false negative ratios. This changed slope behavior is described by K_{False Positive}, the instant rotation speed of the unit vector tangent to the curve described explicitly by FP=FP(ν). For ν estimation, we propose to use the slope changing (“knee”) points as a trade-off for ν selection, computed using the curvature local maxima.

| Measure (name) | Formula | Constraint | Estimated v (%) |
|---|---|---|---|
| false positive to v ratio (FPvR) | $\frac{FP}{v}$ | FPvR < 1 | 2.56 |
| first derivative (FP′) | $\frac{\partial FP}{\partial v}$ | FP′ < 1 | 2.56 |
| Curvature (κ_{FalsePositive}) | $\frac{{FP}^{″}}{{( 1 + {( {FP}^{′} )}^{2} )}^{\frac{3}{2}}}$ | local maximum | 0.64 and 2.56 |

It should be noted that FP″ is the second derivative of FP(v), ${FP}^{″} = \frac{{\partial }^{2} FP}{\partial {v}^{2}} .$

Note that the three measures in the table above produce similar ν estimates. The first maximum of the curvature may be used in cases where producing no FPs is a critical requirement, while a ν in the 2.5% range corresponds to a more realistic model with balanced false positive and false negative ratios. We also analyzed FP=FP(ν) both without cross-validation (i.e. without excluding any dataset from training), and with classical K-fold cross validation (K=10), by using random distribution into training and test groups for the one-class SVM training catchment basins. In some cases we observed that the optimum values for the proposed measures were achieved for ν values in the 0.6% to 5% range. This is to be expected as our model selection heuristic assumes a large separation between in- and outliers that may be difficult to achieve.

In some embodiments, candidate regions can be a group of neighboring voxels and/or pixels. In some embodiments, catchment basins can be computed, for example, using the watershed method. The watershed algorithm can extract regions of low intensity completely surrounded by higher intensity neighbors. Various watershed algorithms are known in the art and can be applied to a neuroimage. Watershed algorithms split an image into areas, based on the topology of the image. For example, the Meyer's Watershed Algorithm includes the following steps:
1. A set of pixels are marked where the flooding shall start. Each marked pixel is given a different label.
2. The neighboring pixels of each marked area are inserted into a priority queue with a priority level corresponding to the gray level of the pixel.
3. The pixel with the highest priority level is extracted from the priority queue. If the neighbors of the extracted pixel have already been labeled and all have the same label, then the pixel is labeled with their label. All non-marked neighbors that are not yet in the priority queue are put into the priority queue.
4. Redo step 3 until the priority queue is empty.
   The non-labeled pixels can produce watershed lines surrounding catchment basins (candidate regions). Various other clustering techniques can be used that produce catchment basin-like voxel clusters that are used as candidate regions. For example, another watershed algorithm, simpler but less precise, could be implemented by estimating local minima as voxels with derivatives below a certain threshold T_{Derivative}, and by thresholding those voxels which have intensities that are close to a local minimum (for example no larger than local minimum plus T_{Derivative}). By applying a region growing algorithm with the seed located at the local minimum, a catchment basin-like structure located around a local minimum can be determined.

The watershed method can produce candidate regions (catchment basins) that can then be further analyzed as plaque containing regions. In some embodiments, the watershed method can partition the neuroimage into candidate regions (catchment basin clusters) such that each candidate region can be analyzed as a whole.

In some embodiments, plaques can include regions with small derivatives surrounded by neighbors with rapidly increasing intensity. Such regions can be considered sources (as opposed to sinks) of the data gradient vector field. Using the Laplacian operator, in some embodiments, the sourceness or sinkness of the gradient vector field can be calculated for each voxel within each candidate region. The Laplacian at each pixel and/or voxel can be computed using neighborhood intensity values. In some embodiments, a high Laplacian value within a candidate region can be consistent with plaque. Various other features associated with plaque regions can also be used to determine plaque regions. Other features can be used to aid in plaque identification such as catchment basin contrast that can be identified by comparing neighbor watersheds with catchment basin minimum. Thus, while some embodiments focus on using a Laplacian to isolate plaque catchment basins, other features can be used without deviating from the spirit and scope of the invention.

A multiscale analysis can be used for the Laplacian values or the Hessian Matrix eigenvalues. That is, process 100 can be applied to images of different resolutions. CBML can be generalized easily either by adding the scale dimension for the Laplacian values and/or by computing the CBML feature as the maximum over the scale dimension or by performing scale-wise comparisons. Although the algorithm is easy to extend from 3D to both lower (2D and 1D) and higher data dimensions, it may need the Laplacian scale property if applied to segment plaques of larger size.

In some embodiments, once the Laplacian is calculated for each pixel and/or voxel within a catchment basin, the highest Laplacian value within each catchment basin can be selected and compared with a threshold value. If the highest Laplacian value within a catchment basin is greater than the threshold value, then the catchment basin is classified as a plaque region. If, on the other hand, the highest Laplacian value within a catchment basin is less than the threshold value, then the catchment basin is not classified as a plaque region.

The threshold value can be determined using a number of techniques. In some embodiments the threshold can be determined by using neuroimages of a control brain that does not have plaques. The highest Laplacian values from the control brain can be used to establish the threshold. In some embodiments, a self-learning algorithm such as the SVM described above can be trained with a known data sample and can be used to determine the threshold value.

In some embodiments, a trained classifier can be used to discriminate the candidates (plaques or parts from other areas of the neuroimage) into plaques or non-plaques based on their features. (e.g., high Laplacian values). In some embodiments, the classifier can be trained in a supervised way, to compute a linear or nonlinear classification function using the features of correctly labeled candidates in a neuroimage that contains both plaques and non-plaques (the ground truth). In other embodiments, a classifier can be used to compute the classification function in an unsupervised way from a sample neuroimage that does not contain plaques, for example, neuroimages from the brains of normal humans or wildtype animals that are known to not include plaques.

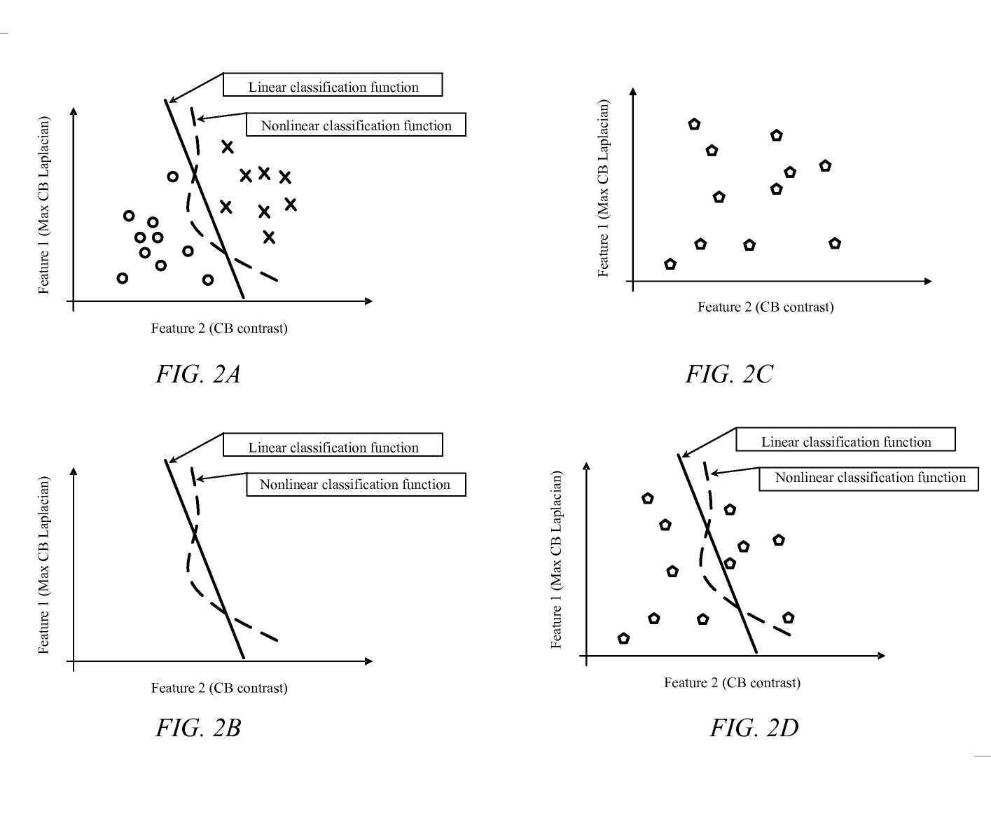

In some embodiments, a classifier can be trained using points within a 2-dimension feature space. Classifiers can also be used in feature spaces with other dimensions, such as 1-dimension, 3-dimension, 4-dimension, etc. For example, the two features can be the maximum Laplacian value within a candidate region and the contrast of the candidate region with the border areas (Laplacian-contrast space). Various other feature spaces with any dimension can be used. As another example, the three features can be the maximum Laplacian value within a candidate region, the contrast of the candidate region with the border areas (Laplacian-contrast space), and/or some function of the Hessian Matrix eigenvalues. Training can occur, for example, in a supervised way by, using known ground truth data that can be obtained with manual (i.e. expensive) work performed by experts and/or using expensive validation techniques (e.g., histology, biopsy). FIG. 2A shows a chart of ground truth data plotted in Laplacian-contrast space. The “∘” data points, in this example, represent data points not in the class (non-plaque regions), and the “x” data points represent data in the class (plaque regions). The classification functions, for example, can be calculated using only the edge data points or all data points. Linear and non-linear classification functions are shown in FIGS. 2A and 2B that can be calculated using various techniques like clustering, neural networks, or SVM. These figures show a training algorithm. By identifying plaque regions of a neuroimage with known plaque regions, a multi-dimensional classification function can be developed.

FIG. 2C shows candidate data from a new sample that can be classified and plotted in feature space. By using the classification function developed in FIG. 2A and FIG. 2B, regions of the new sample can be classified. FIG. 2D shows the candidate data plotted along with the classification functions defined in conjunction with the data points shown in FIG. 2A. As shown, the classification functions discriminate the data points into plaque and non-plaque data points.

In some embodiments, the threshold value can be dependant on the type of neuroimage being analyzed, on a specific brain imaging machine, and/or can change over time. Various examples of determining a threshold are disclosed in the Appendix. In some embodiments, classification can use a threshold in a complex way. This can be done, for example, by creating a separation hyper-plane or a non-linear separation hyper-surface. The direction of comparison (i.e. lower or higher than the threshold, or on one side or another of the classification function) and the direction of flooding in the watershed algorithm can be changed to segment darker or brighter spots respectively.

In some embodiments, plaque load quantification can be determined from plaque distributions. Plaque load (PL) can be defined as calculation of fractional volume of plaques in the whole brain or in a subregion of the whole brain. In some embodiments, plaque frequency distribution (PD) can be determined. PD can be defined as the number of individual plaques per volume. In some embodiments, PL and PD can be used to differentiate between fewer large plaques (low PD) versus numerous small plaques (large PD), when the plaque load values are similar. In some embodiments, 3D distribution analysis in time and space, can reveal information on how the brain circuitry within and between the delineated brain structures can be affected by plaques. In some embodiments, plaque quantification and/or segmentation can ignore plaque shape and size.

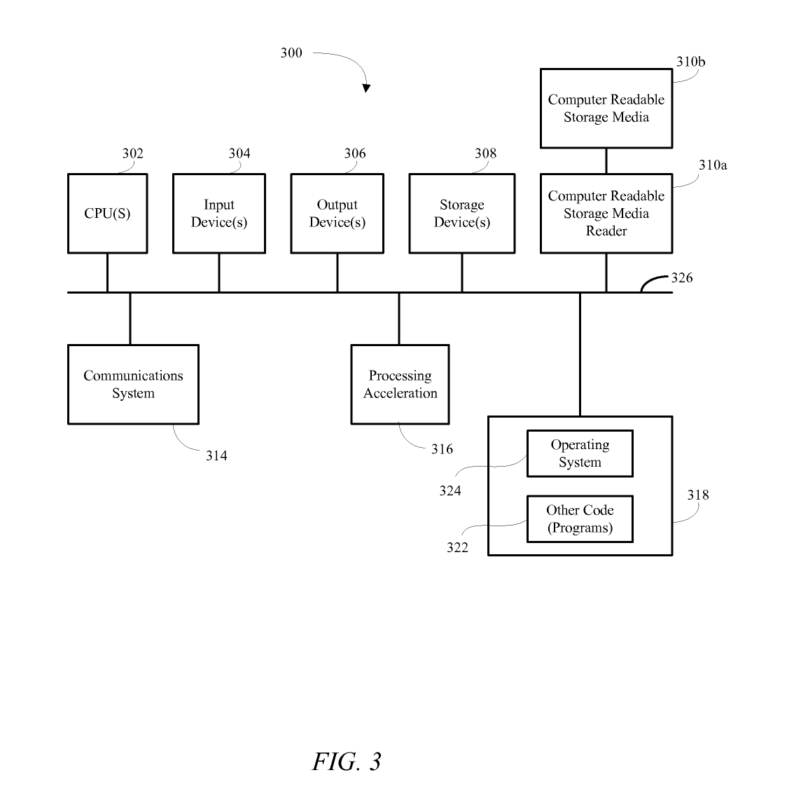

FIG. 3 shows an example of a computational device 300 that can be used to perform various embodiments of the invention such as process 100 shown in FIG. 1. The drawing broadly illustrates how individual system elements can be implemented in a separated or more integrated manner. The computational device 300 is shown comprised of hardware elements that are electrically coupled via bus 326. The hardware elements include processor 302, input device 304, output device 306, storage device 308, computer-readable storage media reader 310a, communications system 314, processing acceleration unit 316 such as a DSP or special-purpose processor, and memory 318. Input device 304, for example, can be used to receive a neuroimage(s) from an external memory or from a brain imager. In some embodiments, the input device 304 can be an image input device. The computer-readable storage media reader 310a is further connected to a computer-readable storage medium 310b, the combination comprehensively representing remote, local, fixed, and/or removable media devices plus storage media readers for temporarily and/or more permanently containing computer-readable information. The communications system 314 can comprise a wired, wireless, modem, and/or other type of interfacing connection and can permit data to be exchanged with external devices, such as a handheld device.

In some embodiments, input device 304 and output device 306 can be a single device, for example, a USB interface. In some embodiments, input device 304 and/or output device 306 can be used to connect the host computer with a handheld device. In some embodiments, input device 304 can be used to receive input from a pointing device such as a mouse, touch screen, touch pad, track ball, etc., and output device 306 can include a visual output device such as a display.

Computational device 300 also comprises software elements, shown as being currently located in memory 318, including an operating system 324 and other code 322, such as a program designed to implement methods described herein. It will be apparent to those skilled in the art that substantial variations can be used in accordance with specific requirements. For example, customized hardware might also be used and/or particular elements might be implemented in hardware, software (including portable software, such as applets), or both. Further, connection to other computing devices such as network input/output devices can be employed.

Software elements can also include software enabling execution of embodiments disclosed throughout this disclosure. For example, software can be stored in working memory 320 that receives home screen and home screen object information from a handheld device, displays home screen representations and/or objects on a display, and allows a user to manipulate the arrangement of objects on one or more home screen representations. The software can also send an indication of the arrangement of objects on the home screen representations to the handheld device.

Embodiments of the invention describe an automatic segmentation algorithm that can be used for amyloid plaque load quantification in neuroimages. Using embodiments described herein, the correlation between neuroimages and histology measured plaque loads is on par with published results comparing expert and automated methods of segmentation from histology images alone. A complex validation scheme has been used to establish the viability of embodiments of this invention with data that includes volumetric ROIs from multiple brain regions in 3D images acquired by two different modalities. Furthermore, histology validation has shown that the proposed one-class SVM ν estimation method is suitable for segmenting plaques in neuroimages and that it can also be used to compute a range where the plaque load values are stable. Even when the ν selection is sub-optimal, the plaque load values are still very well correlated with the histology values, so they can be used as a quantitative index to correctly compare different plaque loads and evaluate the evolution of plaques. Embodiments of the invention can be suitable in single measurements or in longitudinal studies, where both the temporal and the spatial evolution of plaque pattern can be measured. The plaque loads measured in test subjects are consistent with the qualitative pattern of amyloid deposition.

Similarity in the values of plaque load calculated from neuroimages and immunohistochemical sections suggests that our neuroimaging protocol is able to detect the majority of plaques present in various brain regions that are AD relevant, beside the cortex and hippocampus. Results indicate that the segmentation algorithms described herein perform well in quantifying the smaller and/or denser plaques as well as larger and/or less dense plaques. The high correlation seen over a wide range of plaque loads (low to high) in multiple AD relevant brain structures underscores the usefulness of using embodiments described herein. Similarly, embodiments described herein can be used in preclinical studies to monitor therapy that will result in significant reductions of plaque load.

The features chosen for this analysis were selected to characterize the hypo-intense signal areas associated with the presence of plaques in neuroimages. The catchment basin maximum Laplacian (CBML) feature is a good model for the plaque induced local minima. In addition to reduced sensitivity to the background intensity variation, the Laplacian is invariant to the data coordinate system and allows a scalar number to describe the intensity variation along the three orthogonal directions of the gradient vector. CBC describes the local catchment basin contrast and thus may be sensitive to noise, which could cause CBC distributions to overlap for plaque and non-plaque catchment basins. However, the algorithm performance should not be affected as SVM will adjust to this by ignoring CBC, and by building a classification function that is parallel to the CBC axis in the feature space. Both classification features are intensity based, so no assumptions are made about the plaque shape or size, which are expected to vary with amyloid pathology development. This algorithm property makes embodiments described herein suitable for monitoring plaque evolution and for evaluating emerging plaque therapies.

The classification approach for plaque segmentation based on unsupervised SVM used by the proposed algorithm may be more appropriate than the classical supervised SVM approach that uses samples for both classes (i.e. the ground truth) for training Supervised SVM is difficult to implement for plaque segmentation in images because the small size, low contrast and the 3D distribution of plaques make obtaining the ground truth a difficult manual task.

Embodiments of the invention extend to both training algorithms as well as identification algorithms. In some embodiments, a training algorithm can be implemented that can classify features into plaque and non-plaques. The training algorithm can be performed in multi-dimensional space and/or can use linear or non-linear training functions. Various machine learning algorithms can be used for training.

Circuits, logic modules, processors, and/or other components may be described herein as being “configured” to perform various operations. Those skilled in the art will recognize that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

While the process in FIG. 1 is described herein with reference to particular blocks, it is to be understood that the blocks are defined for convenience of description and are not intended to imply a particular physical arrangement of component parts. Further, the blocks need not correspond to physically distinct components.

While the embodiments described above may make reference to specific hardware and software components, those skilled in the art will appreciate that different combinations of hardware and/or software components may also be used and that particular operations described as being implemented in hardware might also be implemented in software or vice versa.

While any type of neuroimage can be used, in some embodiments, a Bruker Avance 14.1T microimager operating at a proton frequency of 600 MHz can be used to generate such an image.

In some embodiments, a neuroimage can include images of any kind including, for example, geographic images, artistic images, medical images, photographs, computer generated images, radar response images, etc.

Computer programs incorporating various features of the present invention may be encoded on various computer readable storage media; suitable media include magnetic disk or tape, optical storage media such as compact disk (CD) or digital versatile disk (DVD), flash memory, and the like. Computer readable storage media encoded with the program code may be packaged with a compatible device or provided separately from other devices. In addition program code may be encoded and transmitted via wired optical, and/or wireless networks conforming to a variety of protocols, including the Internet, thereby allowing distribution, e.g., via Internet download.

Thus, although the invention has been described with respect to specific embodiments, the invention is intended to cover all modifications and equivalents within the scope of the following claims.

What is claimed is:

1. A method for identifying plaques in a neuroimage comprising:
identifying candidate regions within a neuroimage;
identifying features of the candidate regions; and
classifying candidate regions as plaque regions and non-plaque regions based on the features identified in the candidate regions.

2. The method according to claim 1, wherein identifying candidate regions includes identifying catchment basins within the neuroimage.

3. The method according to claim 1, wherein identifying candidate regions includes identifying regions within the neuroimage with low intensity surrounded by regions of high intensity.

4. The method according to claim 1, wherein identifying features of the candidate regions includes identifying candidate regions with features selected from the list consisting of higher Laplacian values, higher Hessian Matrix eigenvalues, and higher local contrast.

5. The method according to claim 1, wherein identifying features of the candidate regions comprises calculating values selected from the list consisting of the Laplacian, the local contrast, and Hessian Matrix eigenvalues.

6. The method according to claim 1, wherein the classifying comprises using support vector learning.

7. The method according to claim 1, wherein the neuroimage is a three-dimensional image and the candidate regions include voxel clusters.

8. The method according to claim 1, wherein the candidate regions are identified as catchment basins.

9. A method for training a process for identifying plaques in a neuroimage, wherein the neuroimage has either or both of known plaque regions and known non-plaque regions, the method comprising:
identifying classification features associated with either or both the plaque regions and the non-plaque regions within the neuroimage; and
developing a classification function based on the classification features.

10. The method according to claim 9, wherein identifying classification features of the candidate regions includes calculating values selected from the list consisting of Laplacian values, Hessian Matrix eigenvalues, and local contrast.

11. The method according to claim 9, wherein identifying classification features of the candidate regions comprises calculating functions selected from the list consisting of the maximum data Laplacian, the local contrast, and Hessian Matrix eigenvalues.

12. The method according to claim 9, wherein the classification features includes a plurality of different types of classification features and the classification function is a multidimensional classification function.

13. The method according to claim 9, wherein the neuroimage is a three-dimensional image and the candidate regions include voxel clusters.

14. The method according to claim 9, wherein the developing a classification function comprises support vector learning.

15. A system comprising:
an image input;
a memory; and
a processor coupled with the image input and the memory, the process configured to:
receive a neuroimage through the image input and storing the neuroimage in the memory;
identify catchment basins within the neuroimage;
identify features of the candidate regions; and
classify catchment basins as plaque regions and non-plaque regions based on the features identified in the catchment basins.

16. The system according to claim 15, wherein the processor identifies features of the candidate regions by identifying candidate regions with features selected from the list consisting of higher Laplacian values, higher Hessian Matrix eigenvalues, and higher local contrast.

17. The system according to claim 15, wherein the processor classifies catchment basins as plaque regions and non-plaque regions using a classification function established with a training algorithm.

18. The system according to claim 15, wherein the processor identifies a plurality of different types of features of the candidate regions and the process classifies catchment basis based on the plurality of different types of features.
